(19) United States
(12) Patent Application Publication
(10) Pub. No.: US 2007/0254131 A1
(43) Pub. Date: Nov. 1, 2007

(54) HOT MELT CARPET TILE AND PROCESS FOR MAKING SAME

(75) Inventors: Todd Shail, Roanoke, VA (US); Frank Endrenyi, Acworth, GA (US); Chris W. Yarbrough, Dalton, GA (US)

Correspondence Address: TROUTMAN SANDERS LLP, 600 PEACHTREE STREET , NE, ATLANTA, GA, 30308, US

(73) Assignee: Mohawk Carpet Corporation, Calhoun, GA (US)

(21) Appl. No.: 11/739,320

(22) Filed: Apr. 24, 2007

Related U.S. Application Data
(60) Provisional application No. 60/745,793, filed on Apr. 27, 2006.

(51) Int. Cl. D05C 17/00; B32B 33/00

(52) U.S. Cl. 428/95; 428/97

(57) ABSTRACT

A carpet tile and process for making the carpet tile, wherein the carpet tile contains tufted face yarn, a primary backing, and at least three polymer-containing layers. The first layer is a pre-coat layer, and the second and third layers each contain a solventless hot melt adhesive that is extruded onto the pre-coat layer.

### CROSS-REFERENCE TO RELATED APPLICATION

The present application claims the benefit of U.S. Provisional Patent Application Ser. No. 60/745,793 filed 27 Apr. 2006, and entitled “Hot Melt Carpet Tile and Process for Making Same,” which is hereby incorporated by reference in its entirety as if fully set forth below.

### BACKGROUND OF THE INVENTION

1. Field of the Invention

The present invention is directed to a carpet tile, and more particularly to a carpet tile and a process for manufacturing the carpet tile having two or more layers of an extruded hot melt adhesive.

2. Description of Related Art

Recently, there has been a growing interest in the use of carpet tiles, rather than rugs and roll carpeting, as carpet tiles offer several advantages. For instance, it is easier and cheaper to install and remove carpet tiles than conventional roll carpeting. Removal of carpet rolls can be very costly in the modern corporate office environment, as open space office concepts with systems furniture becomes the norm. Tiles allow the removal of used carpets by simply lifting the furniture systems, sliding out the old tiles, and sliding in the new tiles. This can save hundreds of thousands of dollars in removal and renovation costs even in modest-size projects.

Additionally, carpet tiles allow the floor covering to be easily repaired. Normally, with conventional roll carpet, any damaged or heavily soiled area is typically cut out and patched with a piece of spare carpeting. Regardless of how well the repair is performed, these patches are usually noticeable and detract from the aesthetic design of the carpet. The alternative is to replace the entire carpet, usually at great expense. However, the use of carpet tiles allows for the removal of individual tiles that have become soiled or damaged. The remaining carpet tiles that are not worn or damaged are simply left in place, thereby maintaining the aesthetic design of the carpet and reducing the cost to repair the damaged carpet. Thus, carpet tiles have become an attractive alternative to conventional roll carpets.

Carpet tiles have conventionally been manufactured by tufting a face fiber into a primary backing then applying a pre-coat adhesive, then a layer of a resilient, aqueous solvent-based thermoplastic adhesive material, both to the backside of the primary backing. For example, conventional carpet tiles may include a face fiber tufted into a primary backing, the backing then covered with a pre-coat adhesive, such as a vinyl acetate ethylene emulsion (VAE), polyvinyl chloride (PVC), plastisol, or acrylic. Once the pre-coat is laid down, the carpet is backed with a layer of a thermoplastic adhesive material. Known thermoplastic adhesive materials include latex, urethane, and vinyl polymers. For most carpet tiles, latex is the most common backing material. Conventional latex materials are aqueous compositions that have a high water content and a very low viscosity. The excess water of the latex compositions is then removed by passing the carpet under a series of expensive drying units.

Unfortunately, these latex-based carpet tiles have several disadvantages. First, since the adhesive is an aqueous solvent-based adhesive, they tend to be non-resistant to moisture. Therefore, latex-based carpet tiles allow moisture to pass through carpet backing and become trapped beneath the carpet tile. The trapped moisture can be difficult to remove and can lead to the formation of mold and mildew, which can degrade the carpet tile and lead to environmental hazards, such as poor air quality. Consequently, the conventional latex backed carpet tiles may need to be frequently replaced if they are used in areas where moisture is a concern.

Second, because latex-based carpet tiles use dissimilar materials for the yarn, the backings, and the adhesives, the carpet tiles cannot easily be recycled. Very expensive, complex and inefficient carpet separation technologies must be developed for recycling. Additionally, these types of recycling processes do not lend themselves to recycle products back into themselves in a continuous closed loop recycling system. The difference in chemical properties between the carpet materials makes it too expensive to separate out the individual components for recycling. As a result, the carpet must be discarded, which adds to the growing landfills around this country. Furthermore, since the polymer components of the latex-based carpeting are not biodegradable, the carpet tiles will remain in the landfills for many years.

Another shortcoming of latex-based pre-coated carpet tiles is the loss of tuft bind performance if carpet is exposed to high moisture or becomes wet. The latex layer will accept water, swell, and allow the tufts to be easily pulled out. It is not unusual for products of this type to lose about 50 percent (%) of their original tuft bind properties.

One solution has been proposed to replace the conventional latex adhesive used for carpet tiles with extruded polyolefin adhesives or polyurethane adhesives. Polyolefin and polyurethane adhesives have good melt indices and have good adhesion properties for a wide range of materials. Also, polyolefin and polyurethane adhesives can be readily recycled. Although polyolefins and polyurethanes have properties that make them attractive for use in carpets, polyolefins and polyurethanes tend to be more expensive when compared with other materials, which increases manufacturing costs.

Hot melt adhesives (HMAs) have been popular for use in conventional roll carpets since they are relatively inexpensive, readily available, and can be easily recycled. They are also popular since they are composed of 100% thermoplastic compounds that do not require a solvent or carrier. A variety of polymers can be used as HMAs, such as copolymers of ethylene and vinyl acetate (EVA), polyolefins, polyamides, and polyesters. However, EVAs are preferred for HMAs because of their wide range of melt indices, good adhesion properties for a wide range of materials, and relatively low cost.

The hot melt adhesives have numerous advantages over solvent based adhesives, such as latex adhesives. The primary advantages include absence of hazardous air pollutants (HAPs) and volatile organic compounds (VOCs) from the manufacturing process. The removal of HAPs and VOCs from the manufacturing process eliminates exposure of these hazardous pollutants to both workers and the environment. Another advantage is that the production costs for carpets using HMAs are less than the production costs for carpets manufactured with aqueous or organic solvent-based adhesives. The costs of the raw components are substantially less than the costs of the component for solvent-based adhesives and equipment costs associated with HMAs are much less than solvent-based adhesives since the need for expensive pollution control equipment is eliminated. Furthermore, since the HMAs cool quickly and do not require special air dryers, or kilns to set the adhesives, products manufactured with HMAs can be manufactured more easily which leads to low cost carpet. However, heretofore, hot melt adhesives have not been used to manufacture carpet tiles.

Therefore, there continues to be a need for a recyclable carpet tile that is inexpensive to manufacture, has good moisture resistance, and provides adequate bind strength to replace conventionally cured latex-backed carpet tile. There is also a need to provide an inexpensive, recyclable carpet tile that uses HMA-containing backings, while achieving good moisture resistance and adequate bind strength. There is also a need for an inexpensive, single pass, continuous process for manufacturing inexpensive, recyclable carpet tiles using HMAs.

### BRIEF SUMMARY OF INVENTION

Briefly described, in its preferred form, the present invention meets the needs described above in a carpet tile having a multi-layer extruded hot melt backing. Generally described, the invention includes a carpet tile having a tufted face yarn, a primary backing, and at least three polymer-containing layers: a pre-coat layer and at least two solventless layers. The pre-coat layer is made from a hot melt adhesive (HMA) that contains at least approximately 20 weight percent (wt %) of a tackifying resin. In exemplary embodiments the pre-coat layer can contain approximately 2 wt % to approximately 80 wt % polyethylene, and approximately 20 wt % to approximately 98 wt % of the tackifying resin. The tackifying resin itself can include, for example, up to approximately 15 wt % of oils, waxes, and anti-oxidants.

The pre-coat layer has a viscosity between approximately 50 centipoise (cps) and approximately 50,000 cps at temperatures between approximately 250 degrees Fahrenheit (° F.), or approximately 121 degrees Celsius (° C.), and approximately 430° F. (221° C.). More preferably, the pre-coat layer has a viscosity between approximately 100 cps and approximately 35,000 cps at temperatures between approximately 330° F. (166° C.) and approximately 425° F. (218° C.), and even more preferably a viscosity of approximately 500 cps at approximately 350° F. (177° C.). The pre-coat layer can be roll coated, extruded, or applied using a conventional slot coater.

The first extruded polymer layer and the second extruded polymer layer are made from solventless HMA compositions. The HMA compositions can include ethylene-vinyl acetate copolymers (EVA), styrene-isoprene-styrene copolymers (SIS), styrene-butadiene-styrene copolymers (SBS), ethylene-ethyl acrylate copolymers (EEA), ultra-low density polyethylene (ULDPE), low density polyethylene (LDPE), polypropylene, ethylene-propylene diene monomer (EPDM), and blends of any of the foregoing (e.g., a blend of polypropylene and EPDM), with EVA being preferred. Either or both of the extruded polymer layers can include a filler. For example, EVA is relatively expensive to use alone, and thus attempts have been made to reduce costs by blending with high levels of relatively cheap extenders, such as fillers. As much as approximately 60 wt % filler may be needed to provide an economically viable composition. As fillers increase viscosity, it is important to use filled HMA compositions with a suitable balance of fluidity and mechanical properties to serve as an adequate polymer layer.

It will be understood by those of skill in the art that references made herein to the general term “hot melt adhesive” or “HMA” compositions will include at times filled HMA (at various ranges), and unfilled HMA; and the disclosed ranges of specifications for such compositions, for example, viscosities, temperatures, and others, will be different for differing filled/unfilled HMA compositions.

For example, if unfilled, the first extruded polymer layer and the second extruded polymer layer of and EVA composition will include approximately 60 wt % to approximately 98 wt % polyethylene and approximately 2 wt % to approximately 40 wt % poly(vinyl-acetate). The copolymer will have a melting point of approximately 140° F. (60° C.) to approximately 450° F. (232° C.), depending on the relative amounts of each component of the copolymer. The unfilled EVA hot melt adhesive also has a viscosity between approximately 250,000 cps and approximately 1,500,000 cps at temperatures between approximately 390° F. (199° C.) and approximately 430° F. (221° C.), and more preferably of approximately 402,000 cps at approximately 410° F. (210° C.).

The first extruded polymer layer and the second extruded polymer layer can also be filled. The blend of polymer (e.g., EVA) to filler is nominally approximately 40 wt % polymer to approximately 60 wt % filler. However, this range can be modified from approximately 10 wt % polymer to approximately 95 wt % polymer, with the filler comprising the remainder of the blend.

More particularly described, the hot melt adhesive of the first extruded polymer layer of the carpet tile is laid down on top of the pre-coat layer in a weight per unit area that is between approximately 2 ounces per square yard (oz/yd²), or approximately 68 grams per square meter (g/m²) based on an approximate conversion of 34 g/m² to 1 oz/yd², and approximately 50 oz/yd² (1700 g/m²), while the second extruded polymer layer is laid down with a greater weight that is between approximately 10 oz/yd² (340 g/m²) to approximately 70 oz/yd² (2380 g/m²). The hot melt adhesive also has a melt flow index between approximately 2 grams per 10 minutes and approximately 250 grams per 10 minutes.

The carpet tile may also contain a scrim placed between the first extruded polymer layer and the second extruded polymer layer to provide dimensional stability. The carpet tile may also contain a cushioned backing attached to the underside of the second extruded polymer layer to provide suitable cushion characteristics to the carpet tile. Alternatively, in place of the cushioned backing, the second extruded polymer layer may contain a foaming agent to provide the desired cushion results to the carpet tile. Finally, the carpet tile may contain one or more topical chemical agents applied to the tufted face yarn, such as a stain blocker, a soil release agent, an anti-static agent, an antimicrobial agent, or combinations thereof.

Various embodiments of the invention are also directed to a process for making carpet tile having at least three HMA layers. The process begins by tufting fiber into a primary backing to form a griege good. The griege good is then fed to a tile coating line, which joins each roll end-to-end so as to make a continuous roll. The griege good then proceeds to an accumulation section that contains either J-boxes, roll accumulators, or a combination of both. The griege good then travels to the first coating station, where a pre-coat layer is applied to the backside of the primary backing using a roll coater. The pre-coat layer is a HMA that comprises at least approximately 20 wt % of a tackifying resin.

The griege good then travels to a first extrusion station where a first layer of a hot melt adhesive, such as EVA, is extruded onto the pre-coat layer while the pre-coat layer is still tacky, for example, still above its glass transition temperature, or at a temperature greater than approximately 100° F. (38° C.). If an unfilled EVA HMA is used, for example, it is composed of approximately 60 wt % to approximately 98 wt % polyethylene and approximately 2 wt % to approximately 40 wt % poly(vinyl-acetate). Nominally, approximately 25 oz/yd² (850 g/m²) of the EVA hot melt adhesive are extruded onto the griege good backing at the first extrusion station. However, anywhere from approximately 10 oz/yd² (340 g/m²) to approximately 50 oz/yd² (1700 g/m²) of the EVA hot melt adhesive may be extruded on top of the pre-coat layer.

While the first layer of the extruded HMA adhesive is still hot and tacky, a scrim can be introduced to the top of the HMA adhesive to provide dimensional stability to the finished carpet tile. The scrim is primarily used to impart dimensional stability. The scrim weighs approximately 2 oz/yd² (68 g/m²), but can range from approximately 0.5 oz/yd² (17 g/m²) to approximately 4 oz/yd² (136 g/m²). Typically, the scrim is made from a nonwoven material, such as fiberglass. Alternatively, the scrim may be woven using fiberglass or other suitable materials.

The griege good then travels to a second extrusion station where a second layer of the hot melt adhesive is extruded on top of the first extruded HMA layer or, if used, the scrim. For an EVA HMA, the EVA composition of the second extruded layer is similar to the EVA composition of the first extruded layer, with the exception that approximately 20 oz/yd² (680 g/m²) to approximately 70 oz/yd² (2380 g/m²), and more preferably approximately 40 oz/yd² (1360 g/m²) to approximately 45 oz/yd² (1530 g/m²) of the EVA HMA is extruded on top of first extruded HMA layer or scrim.

A cushioned backing can then be added on top of the second extruded layer of the hot melt adhesive to provide the suitable cushion results to the carpet tile.

The process of manufacturing the carpet tile may also include applying at least one topical chemical agent to the face fibers. Specific chemical agents include stain blockers, soil release agents, anti-static agents, antimicrobial agents, or a combination thereof. Once the chemical agents are applied, the griege good is then passed through an oven to cure the chemical agents to the face fibers. Next, the tufted backing may be passed through a weft straightener to insure that any patterns are straight before the carpet tile enters the polymer adhesive coating zones.

The process may further include cooling the griege good once all of the polymer layers have been applied by passing it through a series of chilled rollers. The griege good is then cut into individual carpet tiles.

These and other objects, features and advantages of the present invention will become more apparent upon reading the following specification in conjunction with the accompanying drawing figures.

### BRIEF DESCRIPTION OF THE DRAWINGS

FIG. 1 is cross-sectional view of a carpet tile in accordance with some embodiments of the present invention.

FIG. 2 is a logic flow diagram illustrating a process for manufacturing a carpet tile in accordance with some embodiments of the present invention.

### DETAILED DESCRIPTION OF PREFERRED EMBODIMENTS

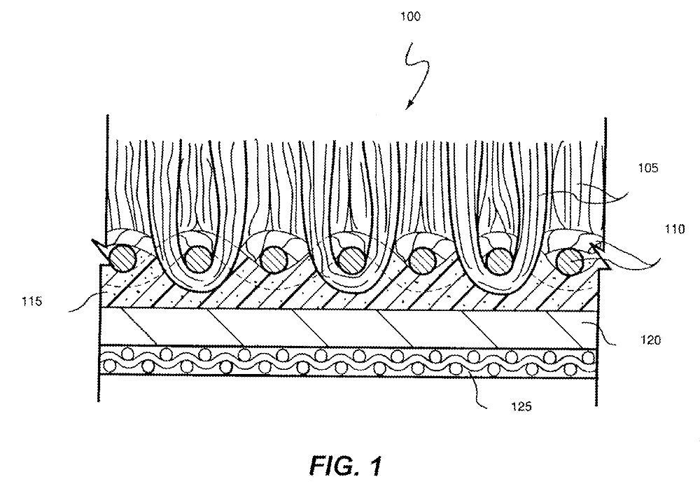

Referring to the figures, in which like numerals refer to like elements through the several figures, FIG. 1 is a cross sectional view of a carpet tile 100 in accordance with various embodiments of the present invention. The carpet 100 includes face yarn 105, which may be either tufted or woven into a primary backing 110 to form a griege good. The face yarn 105 may be made from various materials, both natural and synthetic, including but not limited to nylon 6, nylon 6, 6, cotton, wool, nylon, acrylic, polyester, polyamides, polypropylene, and other polyolefins. The face weight of the face yarn 105 can be approximately 5 oz/yd² (170 g/m²) to approximately 50 oz/yd² (1700 g/m²).

The primary backing 110 is typically formed from a non-woven substrate. The non-woven substrate imparts stability to the carpet tile 100 and also provides the proper drape for the installation process. The non-woven substrate may be made from a polyester, such as poly(ethylene terephthalate) [PET], poly(trimethylene terephthalate) [PTT], poly(butylene terephthalate) [PBT], poly(ethylene terephthalate-co-isophthalate), poly(ethylene naphthalenedicaroxylate) [PEN], and copolymers thereof, with PET being preferred. The non-woven substrate may also be made from a polyester core surrounded by a polyamide sheath. Typically, the polyester core may be made from PET, PTT, PBT, PEN, poly(ethylene terephthalate-co-isophthalate) and copolymers thereof. The polyamide sheath may be made from polycaprolactam [nylon 6], poly(7-heptanamide) [nylon 7], polycapryllactam [nylon 8], poly(9-nonanamide) [nylon 9], poly(tetramethylene adipamide) [nylon 4,6], poly(hexamethylene adipamide) [nylon 6,6], poly(methylene-4,4′-dicyclohexylene dodecanediamede), poly(1,4-cyclohexylenedimethulene suberamide), poly(m-phenylene isophthalamide), and poly(p-phenylene terephthalamide), with polycaprolactam [nylon 6] being the preferred polyamide. Alternatively, the primary backing 110 may be formed using a woven substrate using any conventional natural or synthetic woven material, such as cotton, jute, rayon, paper, nylon, polypropylene and other polyolefins, polyamides, polyesters, and the like or from a combination of a non-woven substrate and a woven substrate.

The face yarn 105 may be tufted through the primary backing 110 so that the ends of the face yarn 105 extend in an outwardly direction from the topside of the primary backing 110. Typically the face yarn is tufted into the primary backing 110 at a weight of approximately 90 g/m² to approximately 200 g/m², and more preferably approximately 120 g/m². The tufting may be performed using conventional techniques that are well known in the art. Furthermore, the tufted face yarn 105 loops may be left as uncut to form an uncut pile carpet, cut to form a cut pile carpet, or partially cut to form a tip sheared carpet, as is well known in the art.

The carpet tile 100 includes a pre-coat layer 115 that is applied on top of the primary backing 110. The main purpose of the pre-coat layer 115 is to penetrate the tufted face yarn 105 and encapsulate the individual ends of the fiber that make the yarn bundles and bind the tufted face yarn 105 to the primary backing 110. This prevents one end of an individual fiber from being pulled out of the carpet backing during the manufacturing process. The pre-coat layer 115 can also act as a tackifier to provide an acceptable binding surface for subsequent polymer layers and provide the right amount of flexibility (drape) to the carpet. In an exemplary embodiment, the pre-coat layer 115 consists of a hot melt adhesive (HMA) that contains a tackifying resin or agent alone or in combination with polyethylene. The tackifying agent preferably comprises at least approximately 20 wt % of the pre-coat layer 115, while the polyethylene comprises the remaining 0 wt % to approximately 80 wt % of the pre-coat layer 115. The tackifying agent more preferably comprises approximately 30 wt % to approximately 80 wt % of the pre-coat layer 115, while the polyethylene comprises the remaining approximately 20 wt % to approximately 70 wt % of the pre-coat layer 115. Most preferably, the tackifying agent comprises approximately 60 wt % of the pre-coat layer 115, while the polyethylene comprises the remaining approximately 40 wt % of the pre-coat layer 115.

The pre-coat layer 115 generally is applied on the primary backing in the range of approximately 2 oz/yd² (68 g/m²) to approximately 20 oz/yd² (680 g/m²), and more preferably in the range of approximately 8 oz/yd² (272 g/m²) to approximately 12 oz/yd² (408 g/m²). The pre-coat layer 115 has a viscosity between approximately 50 cps to approximately 5000 cps at a temperature between approximately 300° F. (149° C.) to approximately 350° F. (177° C.), and more preferably approximately 1,000 cps at approximately 335° F. (168° C.).

The tackifying agent component of the HMA used in the pre-coat layer 115 may be any suitable tackifying agent known generally in the art, such as natural and synthetic resins and rosin materials. Classes of tackifying resins that may be employed are the coumarone-indene resins, terpene resins, including also styrenated terpenes, butadiene-styrene resins, polybutadiene resins, and hydrocarbon resins. The tackifying agent may also include rosin materials, low molecular weight styrene hard resins, disproportionated pentaerythritol esters, and copolymers of aromatic and aliphatic monomer systems. The rosin material may be gum, wood or tall oil rosin. Also the rosin material may be a modified rosin such as dimerized rosin, hydrogenated rosin, disproportionated rosin, or esters of rosin.

Disposed on top of the pre-coat-layer 115 is a first extruded polymer layer 120 whose primary function is to permanently bond the tufted face yarn 105 to the primary backing 110. In an exemplary embodiment, the first extruded polymer layer 120 comprises a HMA, examples of which include but are not limited to ethylene-vinyl acetate copolymers (EVA), styrene-isoprene-styrene copolymers (SIS), styrene-butadiene-styrene copolymers (SBS), ethylene-ethyl acrylate copolymers (EEA), ultra-low density polyethylene (ULDPE), low density polyethylene (LDPE), polypropylene, ethylene-propylene diene monomer (EPDM), and blends of any of the foregoing (e.g., a blend of polypropylene and EPDM), with EVA being preferred.

When the first extruded polymer layer 120 is an EVA hot melt adhesive, the poly(vinyl acetate) content of the EVA may be approximately 2 wt % to approximately 40 wt % of the EVA, and more preferably approximately 8 wt % to approximately 30 wt % of the EVA. The EVA hot melt adhesive has a melt flow index of approximately 0.2 grams per minute (g/min) to approximately 25 g/min, and more preferably about 2.5 g/min. The melting point of the EVA hot melt adhesive is about 140° F. (60° C.) to approximately 450° F. (232° C.), depending on the relative amounts of each component of the copolymer, and more preferably about 180° F. (82° C.), which is above the melting point of the HMA used for the pre-coat layer 115. Generally, approximately 25 oz/yd² (850 g/m²) of the EVA is extruded onto the back of the pre-coat layer 115, however the EVA can extruded onto the pre-coat layer in a range from approximately 10 oz/yd² (340 g/m²) to approximately 50 oz/yd² (1700 g/m²). The extrusion temperature of the EVA hot melt adhesive is preferably approximately 350° F. (177° C.) to approximately 385° F. (196° C.), with acceptable extrusion temperatures being between approximately 275° F. (135° C.) and approximately 450° F. (232° C.). The viscosity of the EVA hot melt adhesive can lie in the range of approximately 250,000 cps to approximately 1,500,000 cps at temperatures between 390° F. (199° C.) and 430° F. (221° C.). More preferably, the EVA hot melt adhesive has a viscosity of approximately 521,000 cps at 390° F. (199° C.), approximately 402,000 cps at 410° F. (210° C.), and approximately 320,000 cps at 430° F. (221° C.).

Beneath the first extruded polymer layer 120 is a second extruded polymer layer 125, which is also a solventless hot melt adhesive. The hot melt adhesive of the second extruded polymer layer 125 can be identical to the composition of the hot melt adhesive used for the first extruded polymer layer 120. However, the hot melt adhesive of the second extruded polymer layer 125 has a heavier application than the first extruded polymer layer 120. In an exemplary embodiment, approximately 20 oz/yd² (680 g/m²) to approximately 70 oz/yd² (2380 g/m²), and more preferably approximately 45 oz/yd² (1530 g/m²) of the hot melt adhesive is extruded onto the back of the first extruded polymer layer 120.

The composition of the hot melt adhesive of either or both the first and second extruded polymer layers can also contain other components. In particular, the hot melt adhesive may include an inert filler material. In one exemplary embodiment, the hot melt adhesive contains approximately 60 wt % inert filler material, while the polymeric component comprises approximately 40 wt % of the hot melt adhesive. In preferred embodiments, the polymeric component comprises approximately 10 wt % to approximately 95 wt %, while the remaining component is filler. For example, a filled EVA HMA will preferably comprise approximately 30 wt % to approximately 40 wt % EVA, with the filler comprising the remainder of the mixture.

The inert filler material may be made from carbonates such as calcium carbonate (CaCO₃), cesium carbonate (CsCO₃), strontium carbonate (SrCO₃), and magnesium carbonate (MgCO₃); sulfates such as barium sulfate (BaSO₃); oxides such as iron oxide (Fe₂O₃ or Fe₃O₄), aluminum oxide (Al₂O₃), tungsten oxide (WO₃), titanium oxide (TiO₂), silicon oxide (SiO₂), silicates, such as clay; metal salts, and the like. Additionally, the inert filler material may be a flame retardant such as, but not limited to, aluminum trihydrate (ATH) or magnesium hydroxide (MgOH) for applications where flame-retardancy is desired.

Additionally, the inert filler material may be made from post-consumer products, such as post-consumer glass, post-consumer carpets and/or other post-consumer recycled materials. In cases where the inert filler is made from post-consumer glass, the post-consumer glass is ground into a fine glass powder before it is added as filler. The glass cullet may be made from automotive and architectural glass, also known as plate glass, flint glass, E glass, borosilicate glass, brown glass (bottle glass), green glass (bottle glass), and coal fly ash, or a combination thereof. In the case where post-consumer carpet is used as the inert filler material, the post-consumer carpet maybe ground into a fine cullet and added to the hot melt adhesive. In addition to the post-consumer carpet, remnants and trimmings of carpet, fine waste fibers that are a result of the shearing process, and the like, that are produced as a by-product during the manufacturing process may also be used to form the inert filler material. Specific examples of post-consumer compositions include post-consumer densified polypropylene carpets comprising approximately 52 wt % polypropylene, approximately 40 wt % CaCO₃ (or other inert filler listed hereinabove), and approximately 8 wt % of a styrene-butadiene-rubber (SBR) latex residue; post-consumer polypropylene fibers that comprise approximately 93 wt % polypropylene, less than approximately 5 wt % nylon, less than approximately 2 wt % ash, and approximately 0.3 wt % of a SBR latex residue; post-consumer densified polyethylene stretch wrap films consisting essentially of polyethylene; post-consumer bottle caps that comprise less than approximately 50 wt % polyethylene, less than approximately 50 wt % polypropylene and less than approximately 1 wt % ash; or a mixture of any of the foregoing post-consumer compositions. The use of post-consumer products provides environmental benefits, as materials that were destined for landfills may be diverted to make new, useful products, such as carpet and carpet tiles 100.

To ensure that the hot melt adhesive flows properly through the extruder, steric acid may be added to act as a lubricant. In addition to providing lubrication, the steric acid also increases the tear strength of the hot melt adhesive. Typically, the steric acid may be added in an amount up to approximately 1 wt % of the filled or unfilled hot melt adhesive, and more preferably approximately 0.2 wt % of the hot melt adhesive.

The filled or unfilled hot melt adhesive may also contain a pigment, such as carbon black or another colorant(s) to provide color and increase the opaqueness of the hot melt adhesive. Typically, the pigment may be present in an amount less than or equal to approximately 1 wt % the filled or unfilled hot melt adhesive, and more preferably approximately 0.1 wt % of the hot melt adhesive.

When certain hot melt adhesives are heated, they may become susceptible to thermo-oxidation degradation. Therefore, to reduce the possibility of thermo-oxidation degradation, the hot melt adhesive may also contain an antioxidant. Some suitable antioxidants include, but are not limited to 2,2′-methylene bis-(4-methyl-6-tert-butylphenol), 2,4,6-tri-tert-butylphenol, 2,6-di-tert-butyl-4-methylphenol, 4,4′-thio-bis-(6-tert-butyl-m-cresol), butylated hydroxy anisole, and butylated hydroxy toluene. Typically, the antioxidant may be present in the filled or unfilled hot melt adhesive in an amount less than or equal to approximately 2 wt % of the adhesive, and preferably approximately 0.01 wt % to approximately 1 wt % of the filled or unfilled hot melt adhesive.

The carpet tile 100 can include an optional scrim 130 disposed between the first extruded polymer layer 120 and the second extruded polymer layer 125. The purpose of the scrim 130 is to impart dimensional stability to the finished carpet tile 100. Typically, the scrim 130 is made from a non-woven material such as fiberglass. However, the non-woven fiber may also be made from polymers such as polyesters, polyamides, polyurethanes, copolymers thereof, blends thereof, and the like. The scrim 130 can also be woven from fiberglass fibers using a leno weave attachment to impart stability to the resultant carpet tile 100.

Beneath the second extruded polymer layer, 125, the carpet tile 100 can contain an optional cushioned backing 135, which can be formed from any conventional thermoplastic material. For example, the cushioned backing 135 may be made from any natural or synthetic rubber such as foam, rubber, polychloroprene, acrylonitrile-butadiene copolymers, ethylene-propylene-diene rubbers, and the like. The cushioned backing 135 may also be made from another polymeric material, such as petroleum resins, vinyl-based polymers, polybutylene resins, polyisobutene-butadiene resins and copolymers thereof, polyvinyl chloride, polyvinylidine chloride, poly(vinyl acetate), poly(vinyl acetal), poly(vinyl butyral), copolymers thereof, and blends thereof The cushioned backing 135 may further include various indentations or corrugations to provide friction between the bottom of the carpet tile 100 and the floor, which provides increased resistance of the carpet tile 100 to movement after it is installed.

In another exemplary embodiment, rather than providing a separate cushioned layer 135, the second extruded polymer layer 125 may contain a foaming agent to produce a foam backing on the carpet. If used, any conventional foaming agent, such as but not limited to, azodicarbonamide, toluene sulfonyl seimcarbazide, and oxy bis(benzene sulfonyl)hydrazide may be used. Normally, the amount of foaming agent depends upon the amount of foaming desired in the adhesive compound. Typically, the foaming agent may be present in the second extruded polymer layer 125 in an amount between approximately 0.1 wt % and approximately 2 wt % of the total weight of the hot melt adhesive (either filled or unfilled), and more preferably approximately 0.75 wt % of the total weight of the hot melt adhesive.

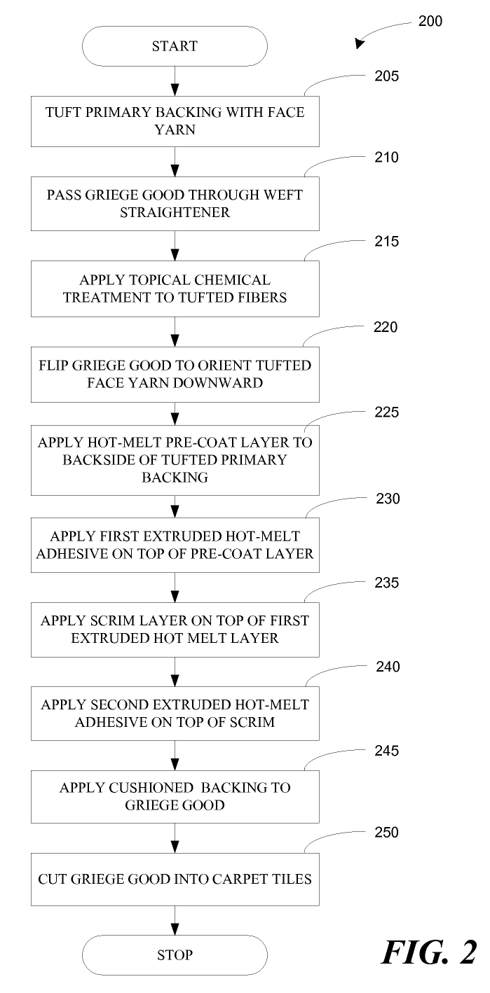

FIG. 2 is a logic flow diagram illustrating a process 200 for manufacturing an inexpensive and recyclable carpet tile 100 in accordance with some embodiments of the present invention. The carpet tile 100 of the present invention is particularly suited to be formed using a continuous process, as described below. The process 200 begins at 205, where yarn 105 is tufted into a primary backing material 110 to form a griege good. The method of tufting or needle punching the yarn to form tufted face fibers 105 into the primary backing material 110 is not critical to the invention. Therefore, the yarn may be tufted using any conventional tufting method or machine. The yarn may be composed of nylon, nylon 6, 6, polyester, propylene, PTT, 3GT, acrylic, wool, cotton, or any combination of thereof. The face weight of the yarns may vary within the range of approximately 10 oz/yd² (340 g/m²) and approximately 50 oz/yd² (1700 g/m²), and more preferably approximately 18 oz/yd² (612 g/m²) to approximately 32 oz/yd² (1088 g/m²). The backing material 110 is fed into the production line in approximately six foot forms, which have a width that ranges between approximately 72 inches (183 centimeters (cm)) and approximately 80 inches (203 cm), and more preferably approximately 76 inches (193 cm).

The griege good is then fed into an accumulator where one or more operators join the ends of each form to one another. Typically, the accumulator may contain j-boxes, roll accumulators, or a combination of both to collect the individual forms. The accumulator allows the operators to sew the ends of the forms together while maintaining a line speed between approximately 10 feet per minute (fpm), which is approximately 3 meters per minute (mpm), and approximately 80 fpm (24 mpm). At this point, the griege good is oriented so that the tufted face fibers 105 are facing upward.

At 210 the tufted face fibers 105 are treated with one or more topical chemicals. The topical chemicals applied to the tufted face fibers 105 may include of stain blockers, such as phenolic resin, methacrylic acid resin, and styrene-maleic anhydride co-polymer, soil release agents, such as hydrophilic colloids like carboxymethylcellulose, synthetic hydrophilic polymers like polyacrylic acid, and fluorochemical-based systems, or anti-static agents, or a combination thereof.

The topical chemicals may be applied onto the tufted face fibers 105 by a sprayer unit or applied as foam. Typically, the topical chemicals are applied to the tufted face fibers 105 at approximate 10 wt % to approximately 14 wt %, based on the overall weight of the fibers. The griege good then proceeds to a topical oven to cure the chemicals to the tufted face fibers 105. Normally, the topical oven operates at a temperature of approximately 250° F. (121° C.) to approximately 350° F. (177° C.), which is well below the melting point of the face fibers 105.

Next, at 215, the griege good is inverted by an inversion unit, which orients the griege good so that the backside of the primary backing 110 is facing upward. Once inverted, the griege good passes through an optional weft straightener at 220. The weft straightener insures that the patterns in the face fibers 105 are properly aligned before the polymer layers are applied to the backside of the griege good.

Once the griege good leaves the weft straightener, the griege good enters a first coating station at 225, in which a first polymer layer 115 is applied to the backside of the griege good. The first polymer layer 115 is generally a hot melt pre-coat adhesive. The hot melt pre-coat layer 115 encapsulates the individual ends of the fibers that make up the yarn bundle to prevent the fibers from “fuzzing” and provide a level of tuft bind strength to prevent one end of the yarn from being pulled out when subjected to normal wear. In addition, the pre-coat layer 115 also acts as a tackifying agent for any additional backing layers that may be applied to the carpet tile 100. The pre-coat layer 115 includes a tackifying agent and, optionally, polyethylene. In an exemplary embodiment, the pre-coat layer 115 comprises approximately 20 wt % to approximately 100 wt % of the tackifying agent, and approximately 0 wt % to approximately 80 wt % polyethylene. The pre-coat adhesive layer 115 is typically applied to the backside of the primary backing 110 at a temperature between approximately 250° F. (121° C.) and approximately 450° F. (232° C.), and more preferably at approximately 350° F. (177° C.). At this temperature, the hot melt layer 115 has a viscosity of approximately 500 cps. The pre-coat layer 115 is applied at a rate of approximately 2 oz/yd² (68 g/m²) to approximately 20 oz/yd² (680 g/m²), and more preferably at a rate of approximately 8 oz/yd² (272 g/m²) to approximately 10 oz/yd² (340 g/m²) using a roll coater.

At 230, the griege good travels to a first extrusion station, in which a first extruded polymer layer 120 is applied onto the top of the hot melt pre-coat layer 115. To provide the optimum tuft bind and adhesion performance, the first extruded polymer layer 120 is applied while the hot melt pre-coat layer 115 is slightly “tacky.” That is, the first extruded polymer layer 120 is applied while the temperature of the hot melt pre-coat layer 115 is still above its softening point, which may be approximately 250° F. (121° C.) to approximately 450° F. (232° C.). In an exemplary embodiment, the first extruded polymer layer 120 is a hot melt adhesive composition. Preferably, the hot melt adhesive composition is EVA. The content of the poly(vinyl-acetate) is between approximately 2 wt % and approximately 40 wt % of the EVA hot melt adhesive and more preferably between approximately 19 wt % and approximately 20 wt % of the EVA, with polyethylene comprising the remaining portion.

The hot melt adhesive may also contain an inert filler material. In an exemplary embodiment, the hot melt adhesive has a composition of approximately 60 wt % of the inert filler material and approximately 40 wt % of the polymer. However, acceptable concentrations of the inert filler material can range between approximately 60 wt % and 95 wt % of the hot melt adhesive. This provides the hot melt adhesive with a melt index in the range of approximately 0.2 g/min to approximately 25 g/min, and more preferably approximately 2.5 g/min. For example, a filled EVA will have a melt index of approximately 1 g/min.

The extruder station is preferably a single screw-type extruder with a barrier screw. However, other types of extrusion processes, such as multi-screw extruders, disc extruders, ram extruders, and the like may be used without departing from the scope of the invention. Normally, the weight of the hot melt adhesive that is extruded onto the backside of the pre-coat layer 115 is approximately 25 oz/yd² (850 g/m²). However, the acceptable weight may range between approximately 10 oz/yd² (340 g/m²) and 50 oz/yd² (1700 g/m²). The hot melt adhesive is preferably extruded through a die so that it forms a sheet of molten HMA that is at least as wide as the griege good. The sheet of molten HMA encapsulates and adheres to the loops of the tufted yarn 105 to permanently lock both the individual fibers and the yarn to the primary backing 110, while maintaining sufficient flexibility and drape required for the carpet tile 100.

At 235, while the temperature of the first extruded polymer layer 120 is still between approximately 150° F. (66° C.) and 450° F. (232° C.), an optional scrim 130 may be placed on top of the first extruded polymer layer 120. The scrim 130 is preferably made of a non-woven fiber, such as fiberglass, which imparts dimensional stability to the carpet.

The griege good next proceeds to a second extrusion station at 240, where a second extruded polymer layer 125 is extruded onto the first extruded polymer layer 120 or the optional non-woven fiberglass scrim 130. In an exemplary embodiment, the second extruded polymer layer 125 is composed of the same hot melt adhesive used for the first extruded layer 120. However, the second extruded layer 125 is applied at a slightly heavier weight than the first extruded layer and has a target weight of approximately 20 oz/yd² (680 g/m²) to approximately 70 oz/yd² (2380 g/m²) and more preferably between approximately 40 oz/yd² (1360 g/m²) and approximately 45 oz/yd² (1530 g/m²).

Next at 245, a cushioned backing 135 may optionally be applied to the griege good. In an exemplary embodiment, the cushioned backing 135 may be laminated to the second extruded polymer layer 125. The cushioned backing 135 may be made of a non-woven material or more preferably a foam backing made from a high density polyurethane, styrene butadiene, poly vinyl-chloride, ethylene vinyl-acetate, and the like. The cushioned backing 135 has have a density in the range of approximately 12 pounds per cubic foot (lbs/ft³), which corresponds to 0.19 grams per cubic centimeter (g/cm³), to 24 lbs/ft³ (0.38 g/cm³), but preferably the density of the cushioned backing 135 is about 18 lbs/ft³ (0.29 g/cm³).

Rather than applying a separate cushioned backing 135, the second extruded polymer layer 125 may contain a foaming agent to produce a foam backing. Any conventional foaming agent, such as but not limited to, azodicarbonamide, toluene sulfonyl seimcarbazide, and oxy bis(benzene sulfonyl) hydrazide may be used. Typically, the foaming agent may be present in the adhesive in an amount between approximately 0.1 wt % and approximately 2.0 wt %, and preferably in an amount of approximately 0.75 wt % of the second extruded polymer layer 125. Once the cushioned backing 135 is in place, the griege good can be cooled by passing the griege good through a series chilled rollers to an exit accumulator so allow the polymer layers to cool to a nominal temperature of approximately 75° F. (24° C.) to approximately 80° F. (27° C.).

Finally, at 250, the griege good is then fed into a die cutter, where the griege good is die cut into the appropriate market-size (e.g., 18″×18″, 24″×24″, or 36″×36″) carpet tiles 100. Alternatively, the griege good may also be taken onto a large diameter (i.e., 8′ diameter) drum where it can be taken to an off-line die cutting station for further processing into carpet tiles 100.

While the invention has been disclosed in its preferred forms, it will be apparent to those skilled in the art that many modifications, additions, and deletions can be made therein without departing from the spirit and scope of the invention and its equivalents as set forth in the following claims.

We claim:

1. A carpet tile, comprising:
fiber;
a primary backing for the fiber;
a pre-coat layer disposed on the primary backing;
a first solventless hot melt adhesive layer disposed on the pre-coat layer; and
a second solventless hot melt adhesive layer disposed on the first solventless hot melt adhesive layer.

2. The carpet tile of claim 1 further comprising a scrim layer between the first and second solventless hot melt adhesive layer layers.

3. The carpet tile of claim 1, wherein the pre-coat layer comprises a tackifying resin.

4. The carpet tile of claim 3, wherein the pre-coat layer further comprises less than or equal to approximately 80 weight percent polyethylene based on a total weight of the pre-coat layer.

5. The carpet tile of claim 1, wherein the first and second solventless hot melt adhesive layers independently comprise an ethylene-vinyl acetate copolymer, styrene-isoprene-styrene copolymer, styrene-butadiene-styrene copolymer, ethylene-ethyl acrylate copolymer, ultra-low density polyethylene, low density polyethylene, polypropylene, ethylene-propylene diene monomer, or a blend comprising at least one of the foregoing.

6. The carpet tile of claim 1, wherein one or both of the first and second solventless hot melt adhesive layers comprise an inert filler.

7. The carpet tile of claim 6, wherein the inert filler comprises approximately 5 weight percent to approximately 90 weight percent of the solventless hot melt adhesive layer.

8. The carpet tile of claim 6, wherein the inert filler is a carbonate, sulfate, oxide, silicate, metal salt, flame retardant, post-consumer recycled product, or a combination of any of the foregoing.

9. The carpet tile of claim 1, wherein the first solventless hot melt adhesive layer has a weight per unit area of approximately 2 ounces per square yard to approximately 50 ounces per square yard.

10. The carped tile of claim 1, wherein the second solventless hot melt adhesive layer has a weight per unit area of approximately 10 ounces per square yard to approximately 70 ounces per square yard, and wherein the weight per unit area of the second solventless hot melt adhesive is greater than the weight per unit area of the first solventless hot melt adhesive layer.

11. The carpet tile of claim 1, further comprising a cushioned backing disposed on the second solventless hot melt adhesive layer.

12. The carpet tile of claim 1, further comprising a topical chemical agent applied to the fiber.

13. A carpet tile, comprising:
fiber;
a primary backing for the fiber;
a pre-coat layer, comprising a tackifying resin, disposed on the primary backing;
a first solventless hot melt adhesive layer disposed on the pre-coat layer; and
a second solventless hot melt adhesive layer disposed on the first solventless hot melt adhesive layer, wherein one or both of the first and second solventless hot melt adhesive layers comprise a copolymer comprising approximately 60 weight percent to approximately 98 weight percent polyethylene and approximately 2 weight percent to approximately 40 weight percent poly(vinyl acetate), based on a total weight of the copolymer.

14. The carpet tile of claim 13, wherein the one or both of the first and second solventless hot melt adhesive layers further comprise approximately 5 weight percent to approximately 90 weight percent of an inert filler, with a balance of the weight being the copolymer.

15. The carpet tile of claim 13, wherein the pre-coat layer further comprises less than or equal to approximately 80 weight percent polyethylene based on a total weight of the pre-coat layer.

16. A method of making a carpet tile, comprising:
tufting a plurality of fibers into a primary backing to form a griege good;
applying a pre-coat layer to the backside of the primary backing of the griege good;
extruding a first solventless hot melt adhesive layer on the pre-coat layer;
extruding a second solventless hot melt adhesive layer on the first solventless hot melt adhesive layer; and
cutting the griege good into individual carpet tiles.

17. The method of claim 16, further comprising disposing a scrim on the first solventless hot melt adhesive layer prior to extruding the second solventless hot melt adhesive layer.

18. The method of claim 16, further comprising disposing a cushioned backing on the second solventless hot melt layer.

19. The method of claim 16, further comprising applying a topical chemical agent to the plurality of fibers.

20. The method of claim 16, wherein extruding one or both of the first and second solventless hot melt adhesive layers comprises extruding a copolymer comprising approximately 60 weight percent to approximately 98 weight percent polyethylene and approximately 2 weight percent to approximately 40 weight percent poly(vinyl acetate), based on a total weight of the copolymer.
